(19) United States
(12) Patent Application Publication
(10) Pub. No.: US 2007/0293596 A1
(43) Pub. Date: Dec. 20, 2007

(54) Means And Method For Producing A Fire Protection Element And Corresponding Fire Protection Element

(75) Inventors: Alexander Reim, Juhnde (DE); Jorg Hansen, Lohfelden (DE)

Correspondence Address: PYLE & PIONTEK;ATTN: THOMAS R. VIGIL, 221 N LASALLE STREET , ROOM 2036, ROOM 2036, CHICAGO, IL, 60601, US

(73) Assignee: AIK Flammadur Brandschutz GmbH, Kassel (DE)

(21) Appl. No.: 11/791,215

(22) PCT Filed: Nov. 25, 2005
(86) PCT No.: PCT/DE05/02138

§ 371 Date: May 21, 2007

(30) Foreign Application Priority Data
Nov. 25, 2004 (DE) 10 2004 056 913.4

(51) Int. Cl. C08G 18/00

(52) U.S. Cl. 521/168

(57) ABSTRACT

An agent and method for manufacturing a fire protection element on the basis of polyurethane foams from a polyol component and a diisocyanate component, the polyol component containing at least one phosphorus-containing polyol and wherein the polyol component and the diisocyanate component do not contain any borate.

This application claims Priority from German Application No. DE 10 2004 056 913.4 filed on 25, Nov. 2004

### BACKGROUND OF THE INVENTION

1. Field of the Invention

The present invention relates to a means for manufacturing a fire protection element according to the preamble of claim 1.

2. Description of the Prior Art

Generic means as well as fire protection elements made therefrom are known from EP 0 400 402 B1. These fire protection elements on the basis of polyurethane foam each contain, beside expandable graphite and usual additives, 2 to 30 wt.-% of borate, melamine and/or ethylene diamine salts as well as phosphorus-containing polyols, the last three components mentioned amounting together to not more than 50 wt.-%.

Such type fire protection elements in the form of moulded parts made from flexible foam serve mainly for sealing passageways for flammable and non-flammable pipes through ceilings and walls. These fire protection elements serve to obstruct the gaps between the pipe and the wall or ceiling. Furthermore, modules or blanks for the flame-retarding sealing of cable through-penetrations may be utilized in shipbuilding. At need, the material may be readily cut to size using a simple knife. Usually however, the appropriate moulded parts are already produced during manufacturing by having the raw materials foamed in an appropriate mould. In the event of a fire, these parts expand and form very strong carbon foam that obstructs the opening, prevents the fire from passing through the passageway and also resists the pressure of the water used for fire fighting (hose stream test).

The integration of these fire protection elements replaces the hitherto usual method for obstructing the gaps of pipe passageways according to which the remaining openings were first filled with mineral wool and have then additionally to be sealed, in most cases on either side, with a fire resistant sealing compound. Since these fire protection elements can be installed from one side of the pipe passageway in only one work step, significant savings in work time are achieved. Dust-free mounting makes processing easier and more convenient, complicated cleaning work is eliminated.

The known fire protection elements usually contain however a borate-containing mineral such as colemanite. This makes the raw materials more expensive.

### BRIEF SUMMARY OF THE INVENTION

It is therefore the object of the present invention to provide a fire protection element, a means as well as a method of manufacturing same that are even lower in cost while providing for good fire protection.

The solution consists of a means for manufacturing a fire protection element having the features of claim 1. According to the invention, there is provided that the polyol component and the diisocyanate component do not contain any borates.

It has been found, surprisingly, that borates, borate-containing minerals in particular, can be dispensed with. Also, the maximum quantity of phosphorus-containing polyol and melamine or ethylene diamine salts of 50 wt.-% needs not be observed, it may be exceeded.

Another subject matter of the invention is a method of manufacturing the new fire protection element according to the claim as well as the resulting fire protection element itself. In the manufacturing method, all the constituent parts are added to the polyol component and mixed together. Then, the diisocyanate component is added and the fire protection element is foamed, at need after the mixture has been filled into a mould.

Advantageous embodiments will become apparent from the dependent claims.

In total, the polyol component should contain 30 to 95 wt.-%, preferably 35 to 75 wt.-%, of at least one binder on the basis of polyol. This binder can be selected from the group comprising polyether polyols, phosphorus-containing polyols and polyethylene glycols. It is preferred that all of these components be contained. Further, up to 50 wt.-% of Bayfomox® PA Component 1 may be contained.

At least one of these polyols may preferably have a relative molar mass of 300-600 and/or the hydroxyl number of 250-270.

The binder preferably contains at least one phosphonic acid ester, preferably N,N-dihydroxyethylene-methylaminophosphonic acid diethyl ester.

The binder may e.g. contain 5-25 wt.-% of polyether polyol (diol) with the hydroxyl number of 250-270 and/or polyether polyol (triol) with the hydroxyl number of 250, 15-40 wt.-% of polyethylene glycols and 10-30 wt.-% of phosphorus-containing polyols, preferably N,N-dihydroxyethylene-methylaminophosphonic acid diethyl ester.

It has been found advantageous if Bayfomox® PA Component 1 was contained as at least one polyol component. Bayfomox® is a trade mark of the Lanxess Deutschland GmbH (formerly Bayer AG) and serves, within the scope of the patent application, to describe one of the components of the means according to the invention for manufacturing a fire protection element. Bayfomox® PA Component 1 is a nitrogen and phosphate containing polyol preparation of the Lanxess Deutschland GmbH that serves as a flame retardant means and has been hitherto sold exclusively with a matched diisocyanate component, Bayfomox® Component 2 L70 in the form of a Bayfomox® raw material system. It has now been found that it is not compulsory to process Bayfomox® PA Component 1 together with the Bayfomox® Component 2 L70 mentioned. The polyol component may but needs not contain 10 to 50 wt.-%, preferably 15 to 45 wt.-%, of Bayfomox® PA Component 1.

An advantage is obtained if at least one filler, which forms an insulation layer, is contained in an amount ranging from 5 to 55 wt.-%, preferably from 9 to 20 wt.-%. This filler may be selected from the group comprising melamine, melamine salts, preferably melamine phosphate, ammonium salts, preferably ammonium polyphosphate, ethylene diamine salts, preferably ethylene diaminophosphate and pentaerythrite. The total fraction of phosphorus-containing polyols and of fillers forming an insulation layer in the subsequent overall mixture of polyol component and diisocyanate component may amount to more than 50 wt.-%.

The polyol component may further contain flame retarding fillers and/or pigments.

Exemplary embodiments of the present invention will be explained in closer detail herein after. The raw material of the fire protection elements consists of two liquid components that are mixed manually or with an automatic dosing and mixing equipment and that are filled into a mould. There, the two components mixed together react to form a flexible foam material and can be removed from the mould after about 15 minutes. This basic manufacturing method corresponds to the known methods of manufacturing polyurethane foams and may also be inferred from the document EP 0 400 402 B1. This manufacturing method may be automated in a well-known manner so that continuous production is made possible.

The component 1 (the resin) of the exemplary embodiment has the following composition:

| Wt.-% | Function | Material |
|---|---|---|
| 0-50% | Bayfomox Pa Comp 1 | Fire protection element |
| | | Lanxess D. GmbH) |
| 30-95% | binder, preferably | Mixture of various |
| | | polyether polyols |
| 30-75% | binder | with phosphorus-containing |
| | | polyols and polyethylene |
| | | glycols with a relative |
| | | molar mass of 300-600, |
| | | e.g., 5-25 wt.-% of |
| | | polyether polyol (diol) |
| | | with the hydroxyl number |
| | | of 250-270 and/or |
| | | polyether polyol (triol) |
| | | with the hydroxyl number |
| | | 250 15-40 wt.-% of |
| | | polyethylene glycols 10-30 wt.-% |
| | | of phosphorus- |
| | | containing polyols |
| | | e.g., N,N- |
| | | dihydroxyethylene- |
| | | methylaminophosphonic acid |
| | | diethyl ester. |
| 5-55% | fillers forming an | mixture of either melamine |
| | | and/or |
| | insulation layer | melamine phosphate and/or |
| | | ammonium polyphosphate |
| | | and/or pentaerythrite |
| | | and/or ethylene |
| | | diaminophosphate |
| 0-25% | flame retarding fillers | aluminum hydroxide |
| 0-1% | pigmentation | iron oxide (black, red or |
| | | yellow) |

The sum of these components amounts to 100 wt.-%. If Bayfomox Pa Comp 1 is contained, the sum of Bayfomox Pa Comp 1 and binder should not be less than 55 wt.-%.

As an option, but not an obligation, blowing agents and/or expanding agents may be added. 0-30 wt.-% of expandable graphite, e.g., Nordmin NM 248 may for example be utilized as the blowing agent. These optional components may individually be optimized for the specifically desired utilization in fire protection. 0-0.8 wt.-% of water may be added as the expanding agent, depending on the desired density of the resulting foam. All the quantities mentioned are based on 100 wt.-% of Component 1.

25-65 wt.-% of 4,4′-methylene-di(phenylisocyanate) (herein after referred to as MDI), e.g., Desmodur 44 V 70 L serves as the Component 2 or as the curing agent, depending on the desired hardness of the foam material. This quantity is also based on 100 wt.-% of Component 1.

### EXAMPLE 1

A mixture of:
249.20 g of Bayfomox PA
175.70 g of a mixture of polyethylene glycol, polyether polyol (diol) with a hydroxyl number of 250-270, N,N-dihydroxyethyl-methylaminophosphonic acid diethyl ester
54.33 g of a mixture of melamine phosphate and ethylene diamine phosphate
17.45 g of aluminum hydroxide
1.74 g of iron oxide red
99.69 g of expandable graphite (e.g., Nordmin NM 248)
2.49 g of water
   was stirred with 199.40 g of MDI. This mixture was filled into a mould with the inner dimensions 50×60×1050 mm and the mould was closed. After about 15 min, the mould was opened again and the finished component, which now had the same dimensions as the mould, was removed. The soft flexible foamed part obtained had a density of about 250 g/L and is suited for sealing pipe passageways through ceilings and walls.

### EXAMPLE 2

A mixture of:
39.23 g of Bayfomox PA
82.95 g of a mixture of polyethylene glycol, polyether polyol (diol) with a hydroxyl number of 250-270, N,N-dihydroxyethyl-methylaminophosphonic acid diethyl ester
25.65 g of a mixture of melamine phosphate and ethylene diamine phosphate
8.27 g of aluminum hydroxide
0.80 g of iron oxide red
31.40 g of expandable graphite (e.g., Nordmin NM 248)
0.80 g of water
   was stirred with 65.90 g of MDI. This mixture was filled into a cylindrical mould with a radius of 25 mm and a length of 500 mm. The mould was closed and after about 15 min a soft flexible cylindrical part with a density of about 260 g/L was removed therefrom. This moulded part can be utilized for the flame retardant sealing of pipe passageways through ceilings and walls.

### EXAMPLE 3

A mixture of:
34.73 g of Bayfomox PA
97.93 g of a mixture of polyethylene glycol, polyether polyol (diol) with a hydroxyl number of 250-270, N,N-dihydroxyethyl-methylaminophosphonic acid diethyl ester
30.28 g of a mixture of melamine phosphate and ethylene diaminophosphate
9.72 g of aluminum hydroxide
0.97 g of iron oxide red
26.05 g of expandable graphite (e.g., Nordmin NM 248) 0.87 g of water
   was stirred with 69.45 g of MDI and filled into a mould with the dimensions 160 mm×130 mm×50 mm. After curing for about 15 minutes, a rectangular, soft flexible moulded block could be removed from the mould. Using a cutter, plates of various thicknesses were cut from this moulded block, said plates being suited for mounting in cable through-penetrations in shipbuilding.

### EXAMPLE 4

A mixture of:
136.50 g of a mixture of polyethylene glycol, polyether polyol (diol) with a hydroxyl number of 250-270, N,N-dihydroxyethyl-methylaminophosphonic acid diethyl ester
42.30 g of a mixture of melamine phosphate and ethylene diaminophosphate
13.50 g of aluminum hydroxide
1.40 g of iron oxide red
38.50 g of expandable graphite (e.g., Nordmin NM 248)
1.30 g of water
   was stirred with 79.50 g of MDI and filled into a mould with the dimensions 50 mm×50 mm×500 mm and the mould was closed. After curing for about 15 minutes, the mould could be opened and the finished part, which now had the same dimensions as the mould, could be removed therefrom. A soft flexible foamed part having a density of about 250 g/L suited for sealing pipe passageways through ceilings and walls was obtained.

### EXAMPLE 5

A mixture of:
138.40 g of a mixture of polyethylene glycol, polyether polyol (diol) with a hydroxyl number of 250-270, N,N-dihydroxyethyl-methylaminophosphonic acid diethyl ester
69.20 g of a mixture of melamine, ammonium polyphosphate and pentaerythrite
20.80 g of aluminum hydroxide
2.30 g of iron oxide red
34.60 g of expandable graphite (e.g., Nordmin NM 248)
0.90 g of water
   was stirred with 80.70 g of MDI and filled into a mould with the dimensions 205 mm×130 mm×50 mm. After curing for about 15 minutes, a rectangular, soft flexible moulded block could be removed from the mould. Using a cutter, plates of various thicknesses were cut from this moulded block, said plates being suited for mounting in cable through-penetrations in shipbuilding.

### EXAMPLE 6

A mixture of:
40.00 g of Bayfomox PA
96.00 g of a mixture of polyethylene glycol, polyether polyol (diol) with a hydroxyl number of 250-270, N,N-dihydroxyethyl-methylaminophosphonic acid diethyl ester
48.00 g of a mixture of melamine, ammonium polyphosphate and pentaerythrite
14.40 g of aluminum hydroxide
1.60 g of iron oxide red
20.00 g of expandable graphite (e.g., Nordmin NM 248)
1.00 g of water
   was stirred with 80.00 g of MDI and filled into a mould with the dimensions 145 mm×200 mm×4 mm. After curing for about 15 minutes, a rectangular, soft flexible moulded block was removed from the mould. This moulded block is suited, inter alia, for mounting in cable through-penetrations in shipbuilding.

### EXAMPLE 7

A mixture of:
104.56 g of a mixture of polyethylene glycol, polyether polyol (diol) with a hydroxyl number of 250-270, N,N-dihydroxyethyl-methylaminophosphonic acid diethyl ester
119.95 g of a mixture of melamine phosphate and ethylene diaminophosphate
1.81 g of iron oxide red
11.32 g of expandable graphite (e.g., Nordmin NM 248)
0.90 g of water
   was stirred with 63.37 g of MDI and filled into a mould with the dimensions 145 mm×200 mm×40 mm. After curing for about 25 minutes, a rectangular, flexible moulded block with a density of about 260 g/L was removed from the mould. This moulded block is suited, inter alia, for mounting in cable through-penetrations in shipbuilding.

1. Means for manufacturing a fire protection element on the basis of polyurethane foams from a polyol component and a diisocyanate component, the polyol component containing at least one phosphorus-containing polyol,
characterized in that the polyol component and the diisocyanate component do not contain any borate.

2. Means according to claim 1,
characterized in that the polyol component contains 30 to 95 wt.-%, preferably 30-75 wt.-% of at least one binder on the basis of polyol.

3. Means according to claim 2,
characterized in that the at least one binder is selected from the group comprising polyether polyols, phosphorus-containing polyols and polyethylene glycols.

4. Means according to claim 3,
characterized in that the at least one binder has a relative molar mass of 300-600 and/or the hydroxyl number 250-270.

5. Means according claim 3,
characterized in that the at least one binder contains 5-25 wt.-% of polyether polyol (diol) with the hydroxyl number 250-270 and/or polyether polyol (triol) with the hydroxyl number 250, 15-40 wt.-% of polyethylene glycols and 10-30 wt.-% of phosphorus-containing polyols, preferably N,N-dihydroxyethylene-methylaminophosphonic acid diethyl ester.

6. Means according to claim 1,
characterized in that the polyol component contains Bayfomox® PA Component 1.

7. Means according to claim 6,
characterized in that the polyol component contains 10 to 50 wt.-%, preferably 15 to 45 wt.-% of Bayfomox® PA Component 1.

8. Means according claim 1,
characterized in that the polyol component contains 5 to 55 wt.-%, preferably 9 to 20 wt.-% of at least one filler forming an insulation layer.

9. Means according to claim 8,
characterized in that the at least one filler forming an insulation layer is selected from the group comprising melamine, melamine salts, preferably melamine phosphate, ammonium salts, preferably ammonium polyphosphate, ethylene diamine salts, preferably ethylene diaminophosphate and pentaerythrite.

10. Means according to claim 1,
characterized in that the polyol component further contains flame retardant fillers and/or pigments.

11. Method of manufacturing a fire protection element on the basis of polyurethane foams from a polyol component and a diisocyanate component,
characterized in that at least one phosphorus-containing polyol containing no borates as well as at need further additives are used for manufacturing the polyol component, a diisocyanate component containing no borates being added to said phosphorus-containing polyol and the reaction mixture being foamed.

12. Method according to claim 11,
characterized in that Bayfomox® PA Component 1 is used.

13. Fire protection element, manufactured from a means according to claim 1.
